(19) United States
(12) Patent Application Publication
(10) Pub. No.: US 2011/0292643 A1
(43) Pub. Date: Dec. 1, 2011

(54) SOLAR PUCKLIGHT WITH BRACKET MOUNT

(76) Inventor: Chi Gon CHEN, Guang Zhou (CN)

(21) Appl. No.: 12/791,678

(22) Filed: Jun. 1, 2010

(51) Int. Cl. F21L 4/08

(52) U.S. Cl. 362/183

(57) ABSTRACT

An improved puck light assembly comprised of a solar-powered puck light mounted in a bracket assembly, which may be securely attached to a structural mounting surface. The puck light device of the present invention is dimensioned to be a hand-held, self-contained, rechargeable, solar-powered lighting assembly. The puck light device of the present invention is mounted in a bracket assembly that allows the puck light to be both recharged and used without repositioning in the bracket assembly. In one embodiment, the bracket assembly comprises a fixed bracket assembly that includes a bracket mount for selectively attaching the bracket assembly to a smooth surface. In another embodiment, the bracket assembly comprises pivoting bracket assembly. The pivoting bracket assembly includes a receiver tray for holding the puck light device, a pivotally attached support bracket connected to a bracket mount for attaching the pivoting bracket assembly to a mounting surface.

### BACKGROUND OF THE INVENTION

1. Technical Field of the Invention

The present invention relates to lighting devices, such as puck lights and other compact lighting devices adapted for convenient mounting and operation. More particularly, the present invention relates to a self-contained solar-powered puck light assembly having a mounting bracket, which simultaneously facilitates its use and recharging.

2. Description of the Related Art

Puck lights (so named because they often resemble hockey pucks in shape) have become increasingly popular as consumer lighting devices. These devices can be used, for example, to conveniently add a light source to small areas that are insufficiently lit by overhead lighting. In one example of a common application, a puck light is mounted to the underside of kitchen cabinet to provide lighting for a countertop. Puck lights and other compact lighting devices also can be used to provide accent lighting and to provide light in areas that may have no other light source, such as storage units and automobiles.

One example of a known puck light is disclosed in U.S. Pat. No. 6,641,283 (Bohler). Bohler describes a battery-powered puck light assembly, which includes light emitting diodes (LEDs) and an optical assembly that “focuses and disperses the LED output to a desired light contour” (abstract). The puck light of Bohler is either hardwired into an AC power connection or powered directly by a DC voltage source, such as a battery system, or by a rechargeable battery system connected to an AC power source (column 6, lines 36-67). The puck light of Bohler is mounted on a base that is permanently attached to an associated structure, such as the underside of a cabinet. The puck light is mounted to the base by means of a fixing apparatus such as a magnet or a recess for receiving the flanged head of a screw fastener. (column 4, lines 18-26)

Another example of a known puck light is disclosed in U.S. Pat. No. 7,562,995 (Levine). Levine discloses a battery-powered lighting device that includes include one or more LEDs within a light assembly. The Levine device includes a first frame element and a second frame element. The light assembly, which is supported by the first frame element, is free to tilt on a first axis relative to the first frame element and rotate relative to the second frame element on a second axis substantially perpendicular to the first axis. The Levine '995 reference further discloses that the second frame element may include an attachment plate configured to be fixedly mounted to a surface, such as a wall.

While prior embodiments of puck lights have proven very useful in a variety of circumstances, they still exhibit a number of limitations, which detract from their usefulness. For example, many embodiments require that they be permanently hardwired into an electrical power source. Moreover, many embodiments are specifically designed to be permanently attached to the underside of a cabinet or shelf, which typically obscures a significant portion of a puck light's planar surface. Thus, a need exists for an improved puck light which is more functional and adaptable to multiple uses.

### SUMMARY OF THE INVENTION

The present invention provides an improved puck light assembly comprised of a solar-powered puck light mounted in a bracket assembly, which may be securely attached to a structural mounting surface. The puck light device of the present invention is dimensioned to be a hand-held, self-contained, rechargeable, solar-powered lighting assembly. In one embodiment of the present invention, the puck light device includes a housing encasing a solar-powered light assembly. The housing includes a front or obverse face, which includes a light projection element in the form of a plurality of light emitting diodes (LEDs) encased under a translucent lens configured in the housing, and a back or reverse face having a solar panel configured therein. The puck light device further includes a power activation switch for turning the light projection element on and off. The puck light device may also include a brightness control switch, which enables the brightness of the light generated by the light projection element to be adjusted by the user.

The housing of the puck light device encases the electronic componentry of the solar-powered light assembly. While the housing may comprise a unitary body formed about the solar-powered light assembly, in a preferred embodiment the housing comprises a two-piece assembly which includes an upper or front portion that includes the front or obverse face, and a lower or back portion that includes the back or reverse face.

The solar-puck light device of the present invention is mounted in a bracket assembly that allows the puck light to be both recharged and used without repositioning in the bracket assembly.

In one embodiment, the bracket assembly comprises a fixed bracket assembly that includes a U-shaped receiver bracket for holding the puck light device and a bracket mount for selectively attaching the bracket assembly to a smooth surface. The bracket assembly may further include an intermediate section, which extends the connection between the receiver bracket to the bracket mount.

The design of the fixed bracket assembly is such that when the puck light device is properly seated in its respective fixed bracket assembly the light projected by the LEDs light assembly of the puck light device is not blocked by the receiver bracket of the bracket assembly nor does the receiver bracket block ambient light from shining on the solar panel of puck light device.

In a preferred embodiment, the fixed bracket assembly includes a suction cup mechanism for selectively attaching the bracket assembly to a smooth transparent surface. A unique and novel design feature of the puck light device and fixed bracket assembly of the present invention is that it permits the combined bracket light assembly to be selectively mounted to a transparent smooth surface; so that when the puck light device is properly mounted the fixed bracket assembly, the puck light device can both recharge by means of its integral solar panel receiving ambient light, and generate and project light by means of its LED light assembly without having to be moved or repositioned within the bracket assembly. Moreover, the puck light device may also be easily removed from the fixed bracket assembly for hand-held use.

In a second embodiment, the bracket assembly comprises pivoting bracket assembly. The pivoting bracket assembly includes a receiver tray for holding the puck light device, a pivotally attached support bracket and a bracket mount for attaching the pivoting bracket assembly to a structural mounting surface. Other embodiments of the pivoting bracket assembly may further include an intermediate mount section, which connects the support bracket to the bracket mount.

The design of the pivoting bracket assembly is such that when the puck light device is properly seated in its respective pivoting bracket assembly the light projected by the light assembly the puck light device is not blocked by the receiver tray. Similarly, the receiver tray does not block ambient light from shining on the solar panel of the puck light device.

The pivoting bracket assembly comprises a support bracket, which is a gimbal that is pivotally attached to opposing sides of the receiver tray. The shape of the support bracket allows the receiver tray to rotate 360° about the pivot points without contacting the rest of the support bracket. The support bracket is connected to the bracket mount and may be either fixably or pivotally attached thereto. The pivoting bracket assembly may further include an intermediate mount section, which connects the support bracket to the bracket mount. The intermediate mount section may be fixably or pivotally attached to either the support bracket or the bracket mount. In a preferred embodiment, all pivotal connections are sufficiently snug so that the pivoting bracket assembly will maintain its angular position once any manual manipulation by a user is concluded. The pivoting bracket assembly also includes a bracket mount for attaching the bracket assembly to a structural mounting surface.

A unique and novel design feature of the pivoting bracket assembly of the present invention is that it permits the combined bracket light assembly to be mounted to a fixed, structural mounting surface; so that when the puck light device is properly mounted the pivoting bracket assembly, the puck light device can both recharge by means of its integral solar panel receiving ambient light, and generate and project light by means of its light assembly without having to be moved or repositioned within the pivoting bracket assembly. In addition, because the receiver tray of the pivoting bracket assembly is pivotally attached to the support bracket, the puck light device, when properly mounted, may also be easily positioned in a wide variety of orientations to take advantage of ambient lighting conditions or to direct the light generated more accurately. Moreover, the puck light device may also be easily removed from the pivoting bracket assembly for use in a hand-held mode.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1A is a front perspective view of an embodiment of the solar-powered puck light device of the present invention;

FIG. 1B is a front plan view thereof;

FIG. 1C is a rear plan view thereof;

FIG. 1D is an exploded view thereof;

FIG. 2A is a front perspective view of an embodiment of the solar-powered puck light device and fixed bracket assembly of the present invention;

FIG. 2B is a rear perspective view thereof;

FIG. 3A is an exploded front plan view thereof;

FIG. 3B is an exploded rear plan view thereof;

FIG. 4 is an exploded side view thereof;

FIG. 5A is a front perspective view of an embodiment of the solar-powered puck light device and pivoting bracket assembly of the present invention;

FIG. 5B is a rear perspective view thereof;

FIG. 5C is an exploded front plan view thereof;

FIG. 5D is an exploded rear plan view thereof;

FIG. 6A is an exploded side view thereof;

FIG. 6B is a front view of the embodiment of the solar-powered puck light device shown in FIG. 6A with the solar-powered puck light device seated within the pivoting bracket assembly;

FIG. 7A illustrates a hand-held use of an embodiment of the solar-powered puck light device of the present invention; and

FIG. 7B illustrates the use of an embodiment of the solar-powered puck light device seated within the pivoting bracket assembly of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

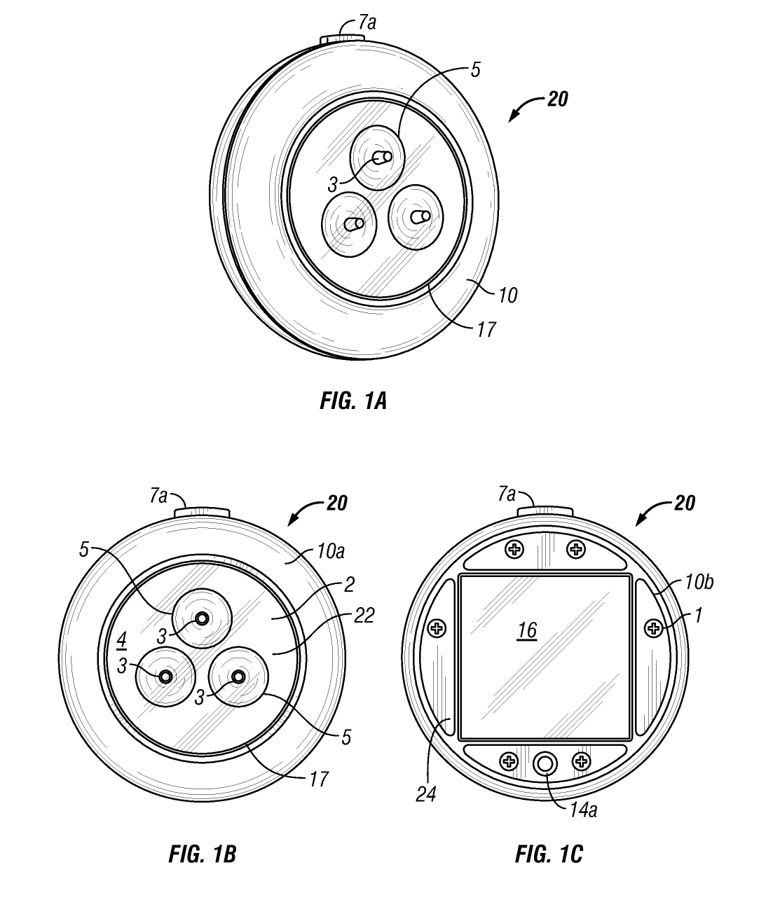

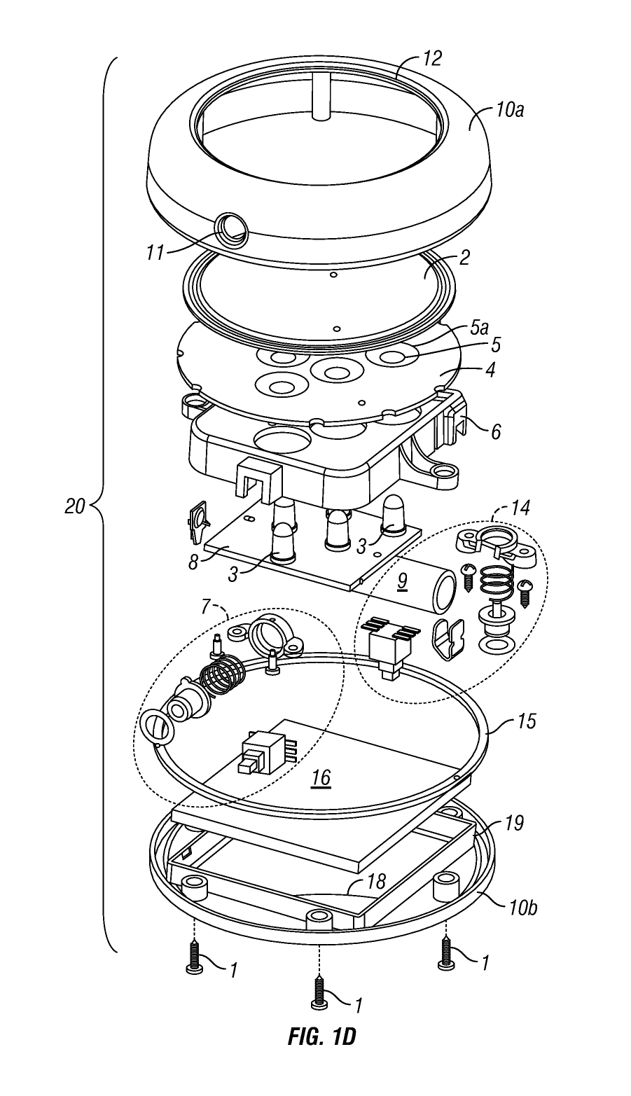

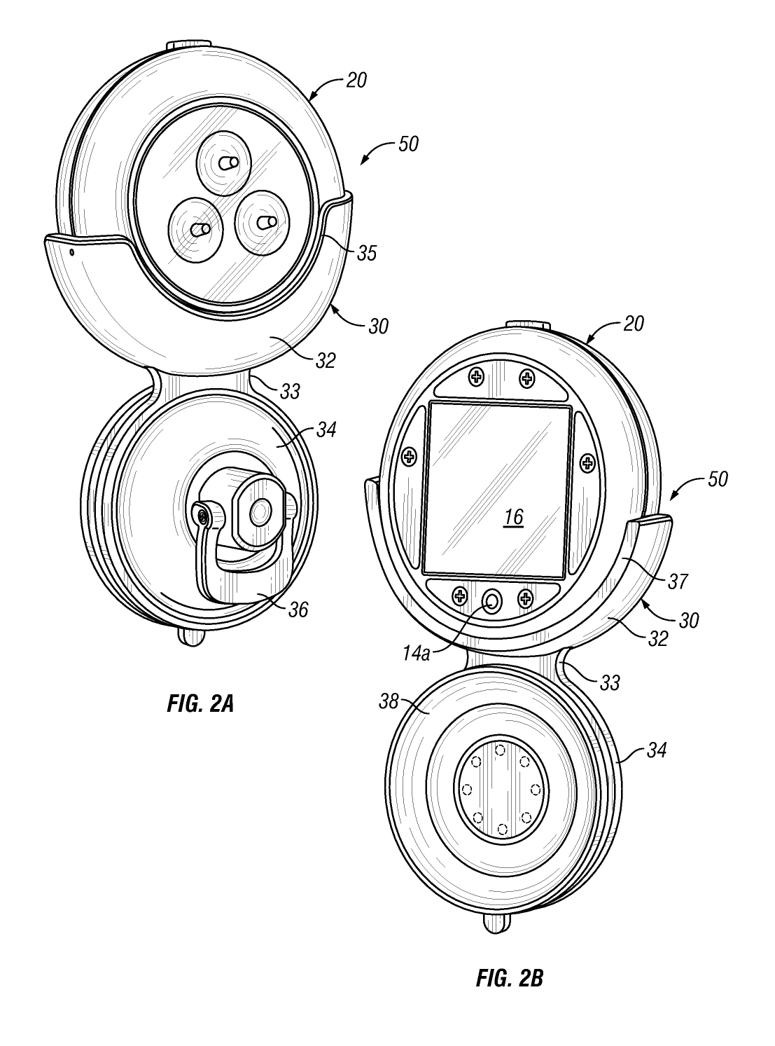

With reference to FIGS. 1A-D, an embodiment of the solar-powered puck light device 20 in accordance with the present invention is shown. The puck light device 20 of the present invention is dimensioned to be a hand-held, self-contained, rechargeable, solar-powered lighting assembly. Preferably, the primary faces of the puck light device 20 of the present invention are no more than three inches in diameter. The puck light device 20 includes a housing 10 encasing a solar-powered light assembly. The housing 10 includes a front or obverse face 22, which includes a light projection element in the form of a plurality of light emitting diodes (LEDs) 3 encased under a translucent lens 2 configured in the housing 10, and a back or reverse face 24 having a solar panel 16 configured therein. The puck light device 20 further includes a power activation switch 7a for turning the light projection element on and off. The puck light device 20 may also include a brightness control switch actuator 14a, which enables the brightness (i.e., the luminance or intensity) of the light generated by the light projection element to be adjusted by the user.

The housing 10 of the puck light device 20 encases the electronic componentry of the solar-powered light assembly. While the housing 10 may comprise a unitary body formed about the solar-powered light assembly, in a preferred embodiment, as shown in FIG. 1D, the housing 10 comprises a two-piece assembly which includes an upper or front portion 10a that includes the front or obverse face 22, and a lower or back portion 10b that includes the back or reverse face 24.

In one embodiment, the two housing assembly portions 10a, 10b are bonded together with screw fasteners 1. Alternatively, the two housing assembly portions 10a, 10b may be bonded together by adhesive bond, frictional bond or heat welding. The housing assembly 10 may also include an o-ring 15 between the housing portions 10a, 10b, which provides a moisture resistant seal between the exterior of the puck light device 20 and the solar-powered light assembly encased within the housing 10.

The front or obverse face 22 of the housing 10 includes an aperture 12 having a translucent lens 2 configured therein. A reflector plate 4 is configured beneath the lens 2. The reflector plate 4 is constructed of highly reflective material so as to project light generated by the LEDs 3 away from the front or obverse face 22 of the puck light device 20. The reflector plate 4 includes a plurality of holes 5, which correspond to and allow LEDs 3 to project through. Each hole 5 includes a conical concavity 5a formed into the surface of the reflector plate 4 to focus the light generated by its respective LED 3.

The electronic componentry of the solar-powered light assembly is configured beneath the reflector plate 4. The electronic componentry includes a printed circuit board 8 having a plurality of LEDs 3 configured thereon so as to align with the plurality of holes 5 in the reflector plate 4. The printed circuit board 8 includes integrated electrical circuitry that provides electrical connectivity between an electrical storage device, such a rechargeable battery 9, and the plurality of LEDs 3.

A power switch assembly 7 is also connected with the electrical circuitry on the printed circuit board 8 to control the flow of electrical energy from the electrical storage device 9 to the LEDs 3. The housing 10 includes a hole 11 that allows an activation switch 7a of the power switch assembly 7 to extend to the exterior of the housing enabling a user to manually activate the power switch assembly 7. While the activation switch 7a depicted in the Figures comprises a push-button mechanism, it is understood that other embodiment of the present invention may comprise toggle switch or rocker switch mechanisms.

A brightness control switch assembly 14 may also be connected to the electrical circuitry on printed circuit board 8 to control the brightness (i.e., the luminance or intensity) of the light generated by the LEDs 3. For example, the brightness control switch assembly 14 may comprise a switch which controls the voltage or the duty cycle of the electrical power supplied from the electrical storage device 9 to the LEDs 3. Alternatively, the brightness control switch assembly 14 may comprise a switch that selectively controls which LEDs 3 are supplied with electrical power from the electrical storage device 9. A manual brightness control switch actuator 14a connected to the brightness control switch assembly 14 extends through the 10 enabling a user to manually activate the brightness control switch assembly 14. While the brightness control switch actuator 14a depicted in the Figures comprises a push-button mechanism configured on the back face 24 of the puck light device 20, it is understood that other embodiments of the present invention may comprise toggle switch or rocker switch mechanisms.

The electronic componentry further includes a photovoltaic cell or solar panel 16, which is electrically connected to the electrical storage device 9 for recharging the electrical storage device 9 in a conventional manner. The solar panel 16 is configured within a frame 19 inset about an aperture 19 in the back face 24 of the housing 10 of the puck light device 20. As depicted in the Figures, the solar panel 16 is configured in the housing 10 of the puck light device 20 so as to access exterior light and convert it into electrical energy that is used to charge the electrical storage device 9.

A battery case 6 may also be configured between the reflector plate 4 and the circuit board 8 to retain, protect and align the electrical storage device 9, printed circuit board 8 and various control switch assemblies. The battery case 6 includes holes which correspond to the configuration of the LEDs 3 extending from the circuit board 8 and through the holes 5 in the reflector plate 4.

While the shape the peripheral surface or edge 26 of the puck light device 20 depicted in the Figures is circular in shape, it is understood that the peripheral shape can, alternatively, be triangular, quadrangular, pentagonal, hexagonal, heptagonal, octagonal or any higher polygonal shape.

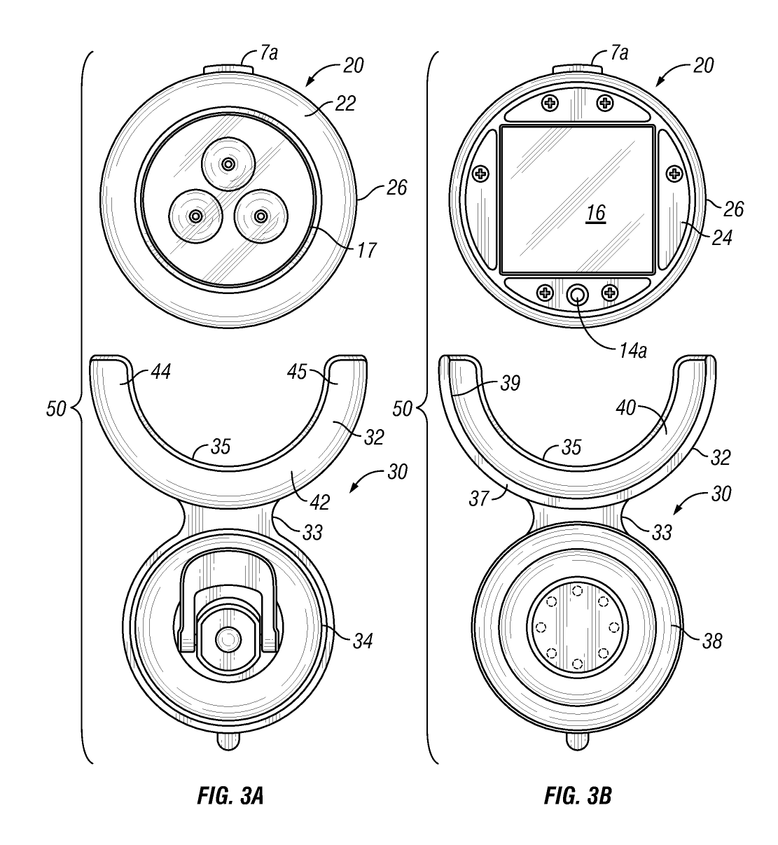

With reference now to FIGS. 2A-2B and 3A-3B, the previously described embodiment of the solar-powered puck light device 20 is shown in combination with an embodiment of the fixed bracket assembly 30 of the present invention. The fixed bracket assembly 30 includes a U-shaped receiver bracket 32 for holding the puck light device 20 and a bracket mount 34 for selectively attaching the bracket assembly 30 to a smooth surface. The bracket assembly 30 may further include an intermediate section 33 which extends the connection between the receiver bracket 32 to the bracket mount 34.

The receiver bracket 32 comprises a trough or channel section 40 having a shape that is substantially complementary to the shape of the housing 10 of the puck light device 20. The receiver trough 40 includes a frontal wall portion 42 and flange 37 along the rear edge that assist in retaining the puck light device 20 within the receiver trough 40 by limiting the forward and aft movement of the puck light device 20 when seated within the receiver trough 40.

The frontal wall portion 42 of the receiver bracket 32 includes an inner peripheral edge 35, which is substantially similar to the outer periphery 17 of the aperture 12 formed in the front face 22 of the puck light device 20, so that when the puck light device 20 is properly seated in its respective fixed bracket assembly 30 the light projected by the LEDs 3 and reflector plate 4 of the puck light device 20 is not blocked by the receiver bracket 32 of the bracket assembly 30. The resulting wings 44, 45 limit the lateral movement of the puck light device 20 when seated within the receiver trough 40 of the fixed bracket assembly 30.

Likewise, the rear retention flange 37 of the receiver bracket 32 comprises an inner peripheral lip 39 extending from the rear edge of the receiver trough 40 that assists in retaining the puck light device 20 within the receiver bracket 32 of the bracket assembly 30, so that when the puck light device 20 is properly seated in its respective fixed bracket assembly 30, the rear retention flange 37 of receiver bracket 32 does not block ambient light 70 from shining on the solar panel 16 of puck light device 20.

The fixed bracket assembly 30 also comprises a bracket mount 34 for selectively attaching the bracket assembly 30 to a smooth surface. The bracket mount 34 is fixably connected to the receiver bracket 32 and includes a mounting surface 31 for attaching the bracket mount 34 to a smooth structural surface. While the mounting surface 31 may be attached to a smooth surface by adhesive bonding, screw fasteners or a hook-and-loop fasteners, in a preferred embodiment the mounting surface 31 includes suction cup mechanism 38 having a cam lever actuator 36. By placing the suction cup mechanism 38 on a smooth surface and selectively moving the cam lever actuator 36 from position A to position B the suction cup mechanism 38 actuates adhering to and gripping the structural surface with a suction force sufficient to hold the fixed bracket assembly 30.

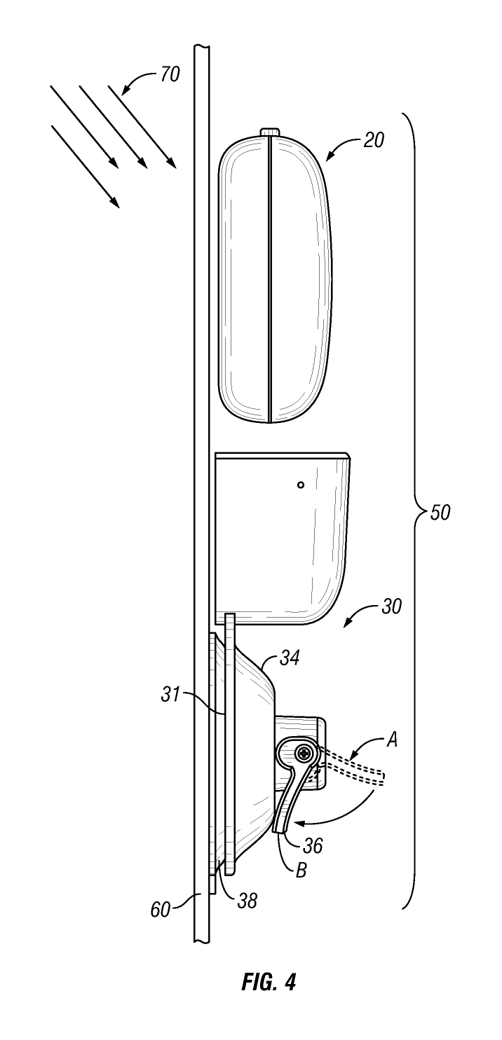

For example, as shown in FIG. 4, a fixed bracket assembly 30 is selectively affixed to a transparent smooth structural surface 60 such as glass or plexiglass by placing the suction cup mechanism 38 on the smooth surface 60 and moving the cam lever actuator 36 from position A to position B. The suction cup mechanism 38 is thereby actuated and adheres to and grips the smooth surface 60 with a suction force sufficient to hold the fixed bracket assembly 30. Conversely, by selectively moving the cam lever actuator 36 from position B to position A the suction force imparted by the suction cup mechanism 38 is reduced allowing the fixed bracket assembly 30 to be easily removed from the smooth surface 60.

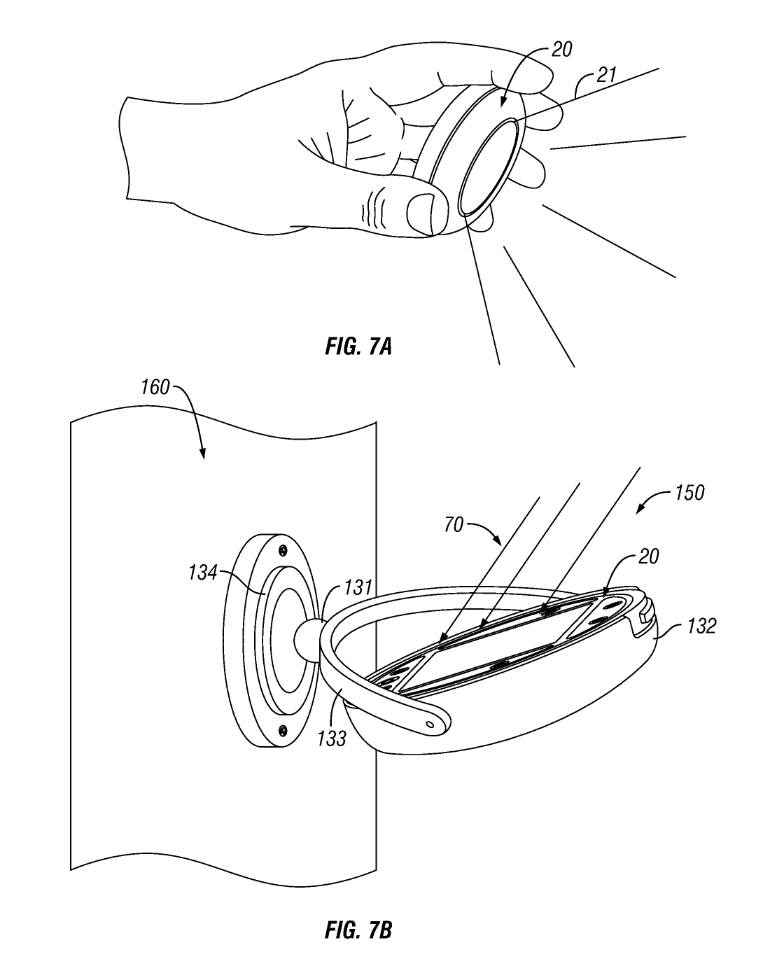

The unique and novel design of the puck light device 20 and fixed bracket assembly 30 of the present invention permits the combined bracket light assembly 50 to be selectively mounted to a transparent smooth surface 60; so that when the puck light device 20 is properly mounted the fixed bracket assembly 30, the puck light device 20 can both recharge by means of its integral solar panel 16 receiving ambient light 70, and generate and project light by means of its LED light assembly 3 without having to be moved or repositioned within the bracket assembly 30. In addition, because the bracket assembly 30 is selectively attached to a wide variety of smooth materials, it can be easily and quickly repositioned to take advantage of ambient lighting conditions. Moreover, as depicted in FIG. 7A, the puck light device 20 may also be easily removed from the fixed bracket assembly 30 to use in a hand-held mode. Thus, the combined bracket light assembly 50 of the present invention greatly improves the efficiency, utility and ease of use of known prior art puck light devices.

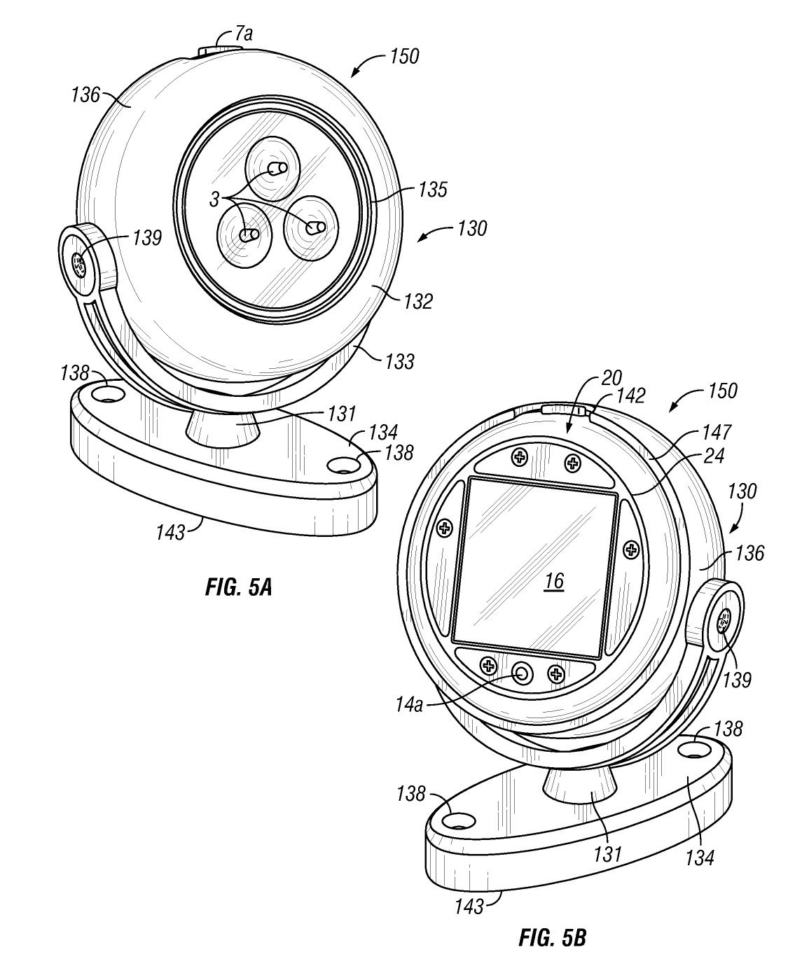

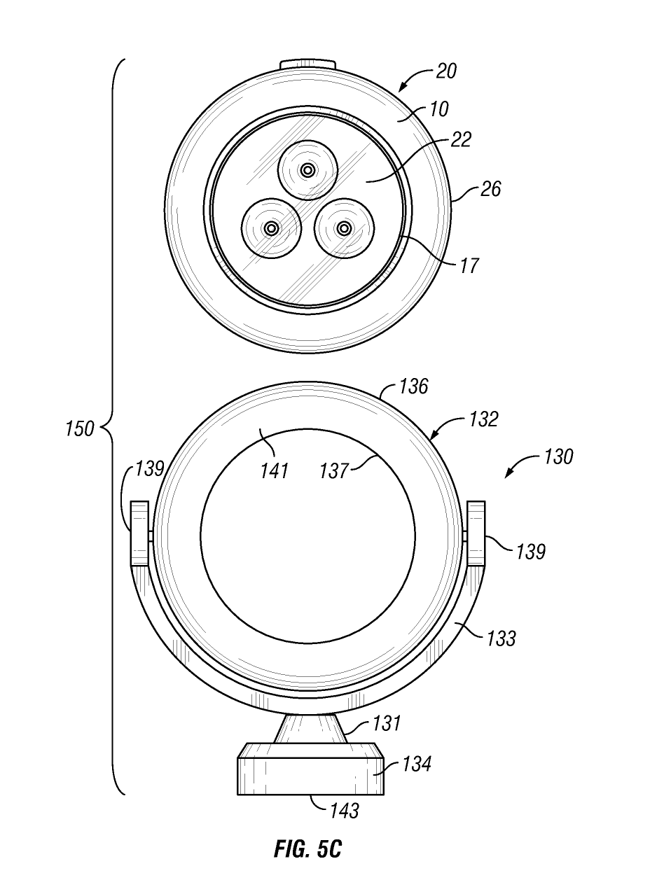

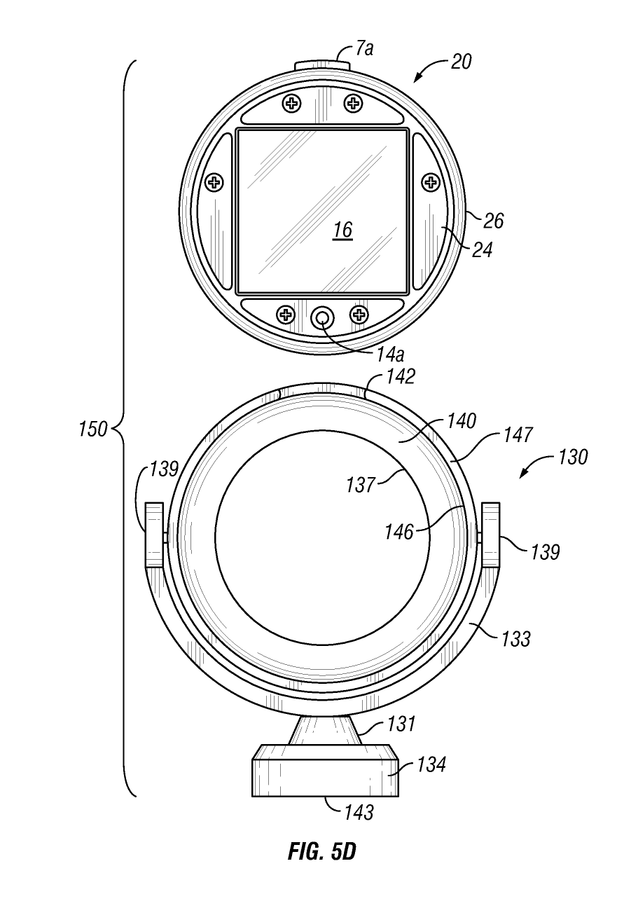

With reference now to FIGS. 5A-5D, an embodiment of a pivoting bracket assembly 130 is shown in combination with the previously described embodiment of the solar-powered puck light device 20. The pivoting bracket assembly 130 includes a receiver tray 132 for holding the puck light device 20, a pivotally attached support bracket 133 and a bracket mount 134 for attaching the pivoting bracket assembly 130 to a structural mounting surface. The support bracket 133 may be either fixably or pivotally attached to the bracket mount 134. The pivoting bracket assembly 130 may further include an intermediate mount section 131, which connects the support bracket 133 to the bracket mount 134. The intermediate mount section 131 extends the connection between the support bracket 133 to the bracket mount 134. The intermediate mount section 131 may be fixably attached or integral to the support bracket 133 or pivotally attached to either the support bracket 133 or the bracket mount 134.

The receiver tray 132 comprises an annular trough or channel section 140 having a shape that is substantially complementary to the shape of the housing 10 of the puck light device 20. The receiver trough 140 includes a frontal wall portion 141 and peripheral wall portion 136 that assist in retaining the puck light device 20 within the receiver trough 140. The frontal wall portion 141 of the receiver tray 132 includes an aperture 137 having an inner peripheral edge 135, which is substantially similar to the outer periphery 17 of the aperture 12 formed in the front face 22 of the puck light device 20, so that when the puck light device 20 is properly seated in its respective pivoting bracket assembly 130 the light projected by the LEDs 3 and reflector plate 4 of the puck light device 20 is not blocked by the receiver tray 132 of the pivoting bracket assembly 130.

Similarly, the peripheral wall portion 136 of the receiver tray 132 is shaped so as to complement the shape of the peripheral surface 26 of the puck light device 20. The annular receiver trough 140 includes a peripheral surface 146 whose shape complements the shape of its respective puck light device 20 so that the puck light device 20 fits snugly into the receiver tray 132. Nonetheless, when the puck light device 20 is properly seated in its respective pivoting bracket assembly 130, the outer edge 147 of the peripheral surface 146 of the annular receiver trough 140 does not block ambient light 70 from shining on the solar panel 16 of puck light device 20. The peripheral surface 146 of the annular receiver trough 140 may also include a cut-out portion 142, which allows the power activation switch 7a of the puck light device 20 to protrude therethrough.

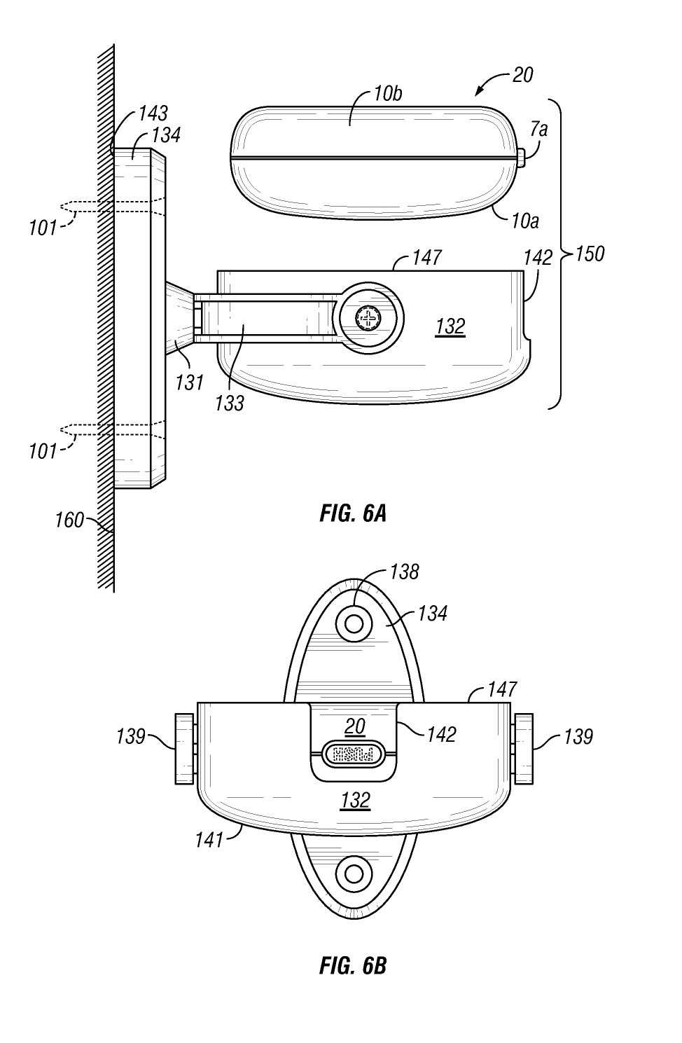

The pivoting bracket assembly 130 also comprises a support bracket 133, which is a gimbal that is pivotally attached to opposing sides of the receiver tray 132. For example, as shown in FIGS. 5A-5D and 6A-6B, the support bracket 133 is a semi-circular gimbal bracket that is pivotally attached via pivot points 139 to opposing sides of the receiver tray 132. The shape of the support bracket 133 allows the receiver tray 132 to rotate 360° about the pivot points 139 without contacting the rest of the support bracket 133. Nonetheless, the pivotal connection between the support bracket 133 and receiver tray 132 is sufficiently snug so that the receiver tray 132 will maintain its angular position relative to that of the support bracket 122 once any manual manipulation by a user is concluded.

The support bracket 133 is connected to the bracket mount 134, typically in the center of the support bracket 133 between the two pivot points 139. The support bracket 133 may be either fixably or pivotally attached to the bracket mount 134. As with the gimbal support bracket 133, any pivotal connection between the support bracket 133 and bracket mount 134 are sufficiently snug so that the support bracket 133 will maintain its angular position relative to that of the bracket mount 134 once any manual manipulation by a user is concluded.

The pivoting bracket assembly 130 may further include an intermediate mount section 131, which connects the support bracket 133 to the bracket mount 134. The intermediate mount section 131 extends the connection between the support bracket 133 to the bracket mount 134. The intermediate mount section 131 may be fixably or pivotally attached to either the support bracket 133 or the bracket mount 134. As with the other previously described pivotal mounts, any pivotal connection between the intermediate mount section 131 and the support bracket 133 or bracket mount 134 are sufficiently snug so that the support bracket 133 will maintain its angular position relative to that of the bracket mount 134 once any manual manipulation by a user is concluded.

The pivoting bracket assembly 130 further includes a bracket mount 134 for attaching the bracket assembly 130 to a structural mounting surface. The bracket mount 134 includes a mounting surface 143 for attaching the bracket mount 34 to a structural mounting surface. While the mounting surface 143 may be attached to a smooth surface by adhesive bonding, hook-and-loop fasteners, or a suction cup mechanism as previously described, in a preferred embodiment of pivoting bracket assembly 130 the mounting surface 143 is attached to the structural mounting surface by means of screw fasteners.

For example, as shown in FIG. 6A, a pivoting bracket assembly 130 is affixed to a structural mounting surface 160, such as masonry or wood, by driving screw fasteners 101 through the bracket mount 134 and into the structural mounting surface 160. The bracket mount 134 may include predrilled holes 138 for accepting such screw fasteners 101.

The unique and novel design of the puck light device 20 and pivoting bracket assembly 130 of the present invention permits the combined bracket light assembly 150 to be mounted to a structural mounting surface 160; so that when the puck light device 20 is properly mounted the pivoting bracket assembly 130, the puck light device 20 can both recharge by means of its integral solar panel 16 receiving ambient light 70, and generate and project light by means of its LED light assembly 3 without having to be moved or repositioned within the pivoting bracket assembly 130. In addition, as depicted in FIG. 7B, because the receiver tray 132 of the pivoting bracket assembly 130 is pivotally attached to the support bracket 133 the puck light device 20 when properly mounted may also be easily positioned in a wide variety orientations to take advantage of ambient lighting conditions or to direct the light generated more accurately. Moreover, as depicted in FIG. 7A, the puck light device 20 may also be easily removed from the pivoting bracket assembly 130 to use in a hand-held mode. Thus, the combined bracket light assembly 150 of the present invention greatly improves the efficiency, utility and ease of use of known prior art puck light devices.

It will now be evident to those skilled in the art that there has been described herein an improved solar-powered puck light and bracket assembly that greatly enhances the efficiency, utility and ease of use of known prior art puck light device. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A solar-powered puck light device comprising:
a housing having two primary faces and encasing a solar powered light assembly, said solar powered light assembly comprising
a) a light emitting assembly configured under a lens positioned in an aperture formed in an obverse primary face of said housing, said light emitting assembly including a plurality of light emitting diodes and a reflector plate,
b) a solar panel for converting ambient light into electrical energy, said solar panel configured in an aperture formed in a reverse primary face of said housing,
c) an electric storage device for storing electrical energy produced by said solar panel and for providing power to said plurality of light emitting diodes, and
d) electrical componentry for controlling the flow of electrical energy from said solar panel to said electric storage device and from said electric storage device to said plurality of light emitting diodes.

2. The solar-powered puck light device of claim 1, wherein said electrical componentry includes a manually actuated power switch assembly.

3. The solar-powered puck light device of claim 1, wherein said electrical componentry includes a manually actuated brightness control switch assembly.

4. The solar-powered puck light device of claim 1, wherein the primary faces of said housing have a diameter that is no larger than 3 inches.

5. The solar-powered puck light device of claim 1, wherein said housing comprises a two-piece assembly, said two-piece assembly comprising a front portion that includes said obverse primary face and a rear portion that includes said reverse primary face.

6. The solar-powered puck light device of claim 1, wherein said housing has a peripheral surface that is circular in shape.

7. The solar-powered puck light device of claim 1, wherein said housing has a peripheral surface shape that is selected from the group consisting of triangular, quadrangular, pentagonal, hexagonal, heptagonal, and octagonal.

8. A bracket assembly for selectively holding a solar-powered light device, comprising:
a receiver bracket for holding said light device, said receiver bracket including a trough section having a shape that is substantially complementary to the shape of said solar-powered light device, said trough section having a frontal wall portion and a rear edge flange which restrict the fore and aft movement of the light device when seated within said receiver bracket, and
a bracket mount fixably connected to said receiver bracket, said bracket mount having a mechanism for selectively mounting said bracket assembly to a structural mounting surface;
wherein, when said light device is properly seated in said receiver bracket said frontal wall portion does not block light projected by said light device, nor does said rear edge flange block ambient light from shining on an integral solar panel of said light device.

9. The bracket assembly of claim 8, wherein said mounting mechanism comprises a suction cup mechanism and said structural mounting surface is smooth and transparent.

10. The bracket assembly of claim 9, wherein said structural mounting surface is glass or plexiglass.

11. The bracket assembly of claim 8, wherein said frontal wall portion of said receiver bracket includes an inner peripheral edge that is substantially similar to the outer periphery of an aperture formed in a face of said light device through which light is projected.

12. The bracket assembly of claim 11, wherein said receiver bracket is generally U-shaped comprising a first and second wing that restrict the lateral movement of the light device when seated in the receiver bracket.

13. The bracket assembly of claim 8, further comprising an intermediate section that extends the connection between said receiver bracket and said bracket mount.

14. A bracket assembly for selectively holding a solar-powered light device, comprising:
a receiver tray for holding said light device, said receiver tray including an annular trough section having a shape that is substantially complementary to the shape of said light device, said trough section having a frontal wall portion and a peripheral wall portion that retain said light device in said receiver tray, said frontal wall portion having an aperture formed therein that is substantially similar to the outer periphery of an aperture formed in a face of said light device through which light is projected;
a gimbal support bracket pivotally attached to opposing sides of said receiver tray;
a bracket mount connected to said gimbal support bracket, said bracket mount having a mechanism for mounting said bracket assembly to a structural mounting surface;
wherein, when said light device is properly seated in said receiver tray said frontal wall portion does not block light projected by said light device, nor does said peripheral wall portion block ambient light from shining on an integral solar panel of said light device.

15. The bracket assembly of claim 12, wherein said solar-powered light device includes a housing having two primary faces and encasing a solar powered light assembly, said solar-powered light assembly further comprising
a) a light emitting assembly configured under a lens positioned in an aperture formed in an obverse primary face of said housing, said light emitting assembly including a plurality of light emitting diodes and a reflector plate,
b) a solar panel for converting ambient light into electrical energy, said solar panel configured in an aperture formed in a reverse primary face of said housing,
c) an electric storage device for storing electrical energy produced by said solar panel and for providing power to said plurality of light emitting diodes, and
d) electrical componentry for controlling the flow of electrical energy from said solar panel to said electric storage device and from said electric storage device to said plurality of light emitting diodes.

16. The bracket assembly of claim 12, wherein said bracket mount is pivotally connected to said gimbal support bracket.

17. The bracket assembly of claim 12, wherein said peripheral wall portion includes a cut-out portion that allows a power activation switch on said light device to protrude through said receiver tray.

18. The bracket assembly of claim 12, further comprising an intermediate mount section connected between said gimbal support bracket and said bracket mount.

19. The bracket assembly of claim 16, wherein said intermediate mount section is pivotally attached to said bracket mount.

20. The bracket assembly of claim 15, wherein said intermediate mount section is pivotally attached to said gimbal support bracket.
